(19) United States
(12) Patent Application Publication
(10) Pub. No.: US 2025/0356648 A1
(43) Pub. Date: Nov. 20, 2025

(54) METHOD FOR TRAFFIC SIGN QUALITY ASSESSMENT

(71) Applicant: GM Global Technology Operations LLC, Detroit, MI (US)

(72) Inventors: Fahim Ahmed, Troy, MI (US); Donald K. Grimm, Utica, MI (US); Richard Gordon, Canton, MI (US)

(73) Assignee: GM Global Technology Operations LLC, Detroit, MI (US)

(21) Appl. No.: 18/666,156

(22) Filed: May 16, 2024

(51) Int. Cl. G06V 10/98; G06T 7/00; G06T 7/90; G06V 10/56; G06V 10/75; G06V 10/762; G06V 20/58

(52) U.S. Cl. CPC G06V 10/993; G06T 7/0002; G06T 7/90; G06V 10/56; G06V 10/75; G06V 10/762; G06V 20/58; G06T 2207/10024; G06T 2207/30252

(57) ABSTRACT

A method includes receiving image data captured by a traffic feature detection system. The image data is representative of a traffic feature within an environment. The method includes identifying a type of the traffic feature. The method includes isolating a portion of the image data containing the traffic feature. Based on the portion of the image data containing the traffic feature, the method includes determining a pixel color value for the traffic feature. Based on the type of the traffic feature, the method includes determining an expected pixel color value for the traffic feature. Based on a comparison of the expected pixel color value and the determined pixel color value for the traffic feature, the method includes determining a health status for the traffic feature.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to systems and methods for determining a health status or quality assessment of traffic features. More particularly, the present disclosure relates to determining the health status of traffic features based on image data captured by a traffic feature detection system of a vehicle and processing the captured image data to compare colors and contrast ratios of the traffic feature to expected values.

Over time, traffic features, such as stop signs, speed limit signs, street signs, and the like, are damaged or degraded. Traditionally, municipalities and road authorities tasked with fixing or replacing traffic features rely on manual inspection or individual complaints to identify traffic features that require repair or replacement. Accordingly, issues with traffic features are often not addressed until their reduced quality materially affects road safety.

### SUMMARY

One aspect of the disclosure provides a computer-implemented method that when executed on data processing hardware causes the data processing hardware to perform operations. The operations include receiving image data captured by a traffic feature detection system. The image data is representative of a traffic feature within an environment. The operations include identifying a type of the traffic feature. The operations include isolating a portion of the image data containing the traffic feature. Based on the portion of the image data containing the traffic feature, the operations include determining a pixel color value for the traffic feature. Based on the type of the traffic feature, the operations include determining an expected pixel color value for the traffic feature. Based on a comparison of the expected pixel color value and the determined pixel color value for the traffic feature, the operations include determining a health status for the traffic feature.

Implementations of the disclosure may include one or more of the following optional features. In some implementations, determining the pixel color value for the traffic feature includes determining, via k-means clustering, one or more clusters of pixel color values. Further, determining the pixel color value for the traffic feature includes determining the pixel color value for the traffic feature based on an average value of a primary cluster of the one or more clusters of pixel color values.

In some examples, the comparison of the expected pixel color value and the determined pixel color value is based on Euclidean distance between the expected pixel color value and the determined pixel color value. The expected pixel color value and the determined pixel color value are represented by one selected from the group consisting of (i) RGB coordinate values, (ii) HSV coordinate values, (iii) HSL coordinate values, and (iv) YUV coordinate values. In some aspects, the health status for the traffic feature is further based on a determined contrast ratio of the traffic feature.

In some implementations, the operations further include isolating a second portion of the image data that surrounds the portion of the image data containing the traffic feature. Moreover, the operations include determining a pixel color value for the environment based on the second portion of the image data. In further implementations, the health status for the traffic feature is further based on a comparison of the determined pixel color value for the traffic feature and the determined pixel color value for the environment.

In some examples, the image data is aggregated from traffic feature detection systems equipped at a plurality of vehicles. In some aspects, the comparison of the expected pixel color value and the determined pixel color value is based on a level of ambient light present in the image data. In some implementations, the operations further include, based on the determined health status for the traffic feature, adjusting operation of the traffic feature detection system. Further, the operations may further include, based on the determined health status for the traffic feature being indicative of degradation, generating an alert to repair the traffic feature.

Another aspect of the disclosure provides a system. The system includes memory hardware storing instructions that, when executed on data processing hardware in communication with the memory hardware, cause the data processing hardware to perform operations. The operations include receiving image data captured by a traffic feature detection system. The image data is representative of a traffic feature within an environment. The operations include identifying a type of the traffic feature. The operations include isolating a portion of the image data containing the traffic feature. Based on the portion of the image data containing the traffic feature, the operations include determining a pixel color value for the traffic feature. Based on the type of the traffic feature, the operations include determining an expected pixel color value for the traffic feature. Based on a comparison of the expected pixel color value and the determined pixel color value for the traffic feature, the operations include determining a health status for the traffic feature. This aspect may include one or more of the following optional features.

In some implementations, determining the pixel color value for the traffic feature includes determining, via k-means clustering, one or more clusters of pixel color values. Further, determining the pixel color value for the traffic feature includes determining the pixel color value for the traffic feature based on an average value of a primary cluster of the one or more clusters of pixel color values.

In some examples, the comparison of the expected pixel color value and the determined pixel color value is based on Euclidean distance between the expected pixel color value and the determined pixel color value. The expected pixel color value and the determined pixel color value are represented by one selected from the group consisting of (i) RGB coordinate values, (ii) HSV coordinate values, (iii) HSL coordinate values, and (iv) YUV coordinate values. In some aspects, the health status for the traffic feature is further based on a determined contrast ratio of the traffic feature.

In some aspects, the operations further include isolating a second portion of the image data that surrounds the portion of the image data containing the traffic feature. Further, the operations include determining a pixel color value for the environment based on the second portion of the image data. Determining the health status for the traffic feature is further based on a comparison of the determined pixel color value for the traffic feature and the determined pixel color value for the environment. In some implementations, the image data is aggregated from traffic feature detection systems equipped at a plurality of vehicles.

Yet another aspect of the disclosure provides a vehicle. The vehicle includes memory hardware storing instructions that, when executed on data processing hardware in communication with the memory hardware, cause the data processing hardware to perform operations. The operations include receiving image data captured by a traffic feature detection system. The image data is representative of a traffic feature within an environment. The operations include identifying a type of the traffic feature. The operations include isolating a portion of the image data containing the traffic feature. Based on the portion of the image data containing the traffic feature, the operations include determining a pixel color value for the traffic feature. Based on the type of the traffic feature, the operations include determining an expected pixel color value for the traffic feature. Based on a comparison of the expected pixel color value and the determined pixel color value for the traffic feature, the operations include determining a health status for the traffic feature. This aspect may include one or more of the following optional features.

In some implementations, determining the pixel color value for the traffic feature includes determining, via k-means clustering, one or more clusters of pixel color values. Further, determining the pixel color value for the traffic feature includes determining the pixel color value for the traffic feature based on an average value of a primary cluster of the one or more clusters of pixel color values.

In some examples, the comparison of the expected pixel color value and the determined pixel color value is based on Euclidean distance between the expected pixel color value and the determined pixel color value. The expected pixel color value and the determined pixel color value are represented by one selected from the group consisting of (i) RGB coordinate values, (ii) HSV coordinate values, (iii) HSL coordinate values, and (iv) YUV coordinate values. In some aspects, the health status for the traffic feature is further based on a determined contrast ratio of the traffic feature.

In some aspects, the operations further include isolating a second portion of the image data that surrounds the portion of the image data containing the traffic feature. Further, the operations include determining a pixel color value for the environment based on the second portion of the image data. Determining the health status for the traffic feature is further based on a comparison of the determined pixel color value for the traffic feature and the determined pixel color value for the environment. In some implementations, the image data is aggregated from traffic feature detection systems equipped at a plurality of vehicles.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is an environmental view of a vehicle travelling along a road.

FIG. 2 is a system diagram of a traffic feature detection system of the vehicle and a backend system in communication with the traffic feature detection system.

FIG. 3 is a flow diagram of an example method of determining a health status for a traffic feature in the environment of the vehicle.

FIG. 4 is a schematic diagram of image data being processed for determining the health status for the traffic feature represented by the image data.

FIG. 5 is a chart depicting example data generated by the traffic feature detection system for determining the health status.

FIGS. 6-8 are charts depicting determined Euclidean distance and contrast ratio values for a stop sign as the colors of the stop sign fade over time.

FIG. 9 is a chart comparing determined environmental contrast ratios for traffic features to determined health status values for the traffic features.

FIG. 10 is a chart comparing determined environmental contrast ratios for traffic features to determined contrast ratios for the traffic features.

FIG. 11 is a chart comparing determined environmental contrast ratios for traffic features to determined health status values for the traffic features.

FIG. 12 is a chart comparing determined chromaticity values for traffic features to an expected federally recommended ideal chromaticity value for the type of traffic feature.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

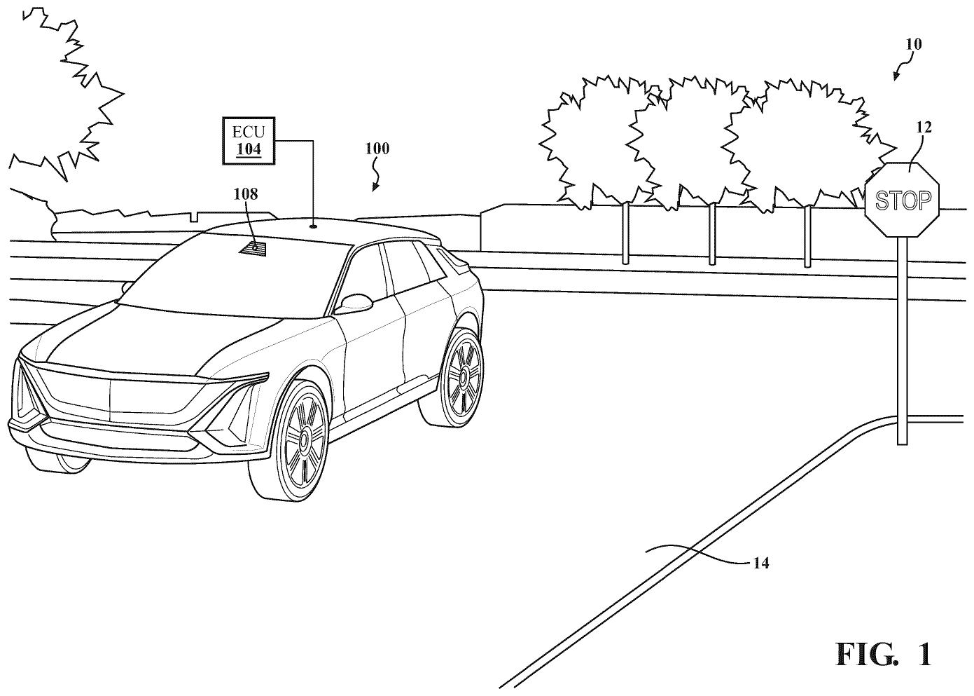

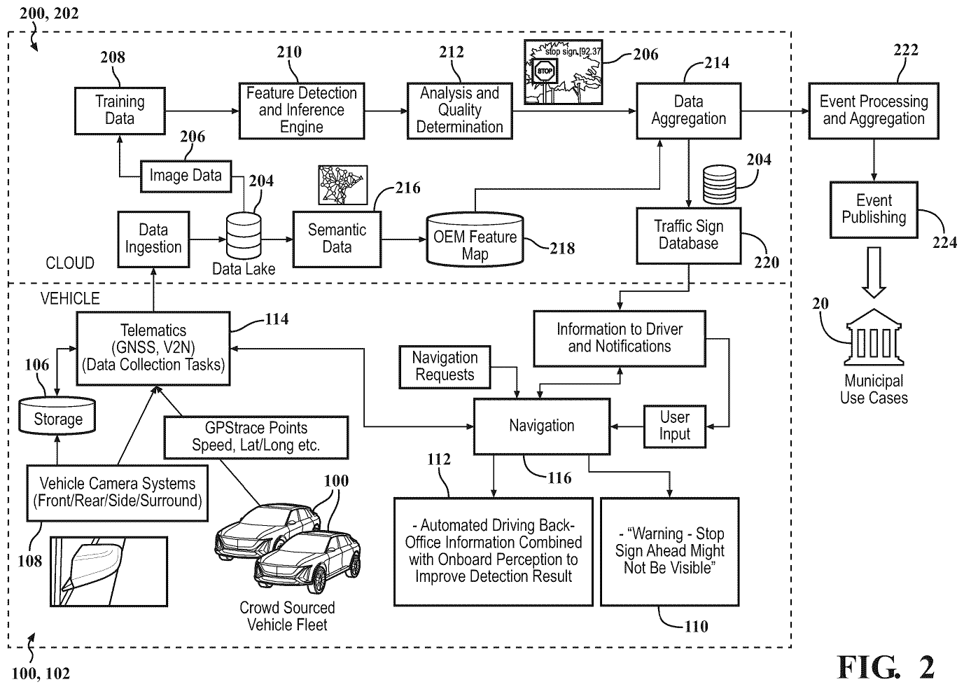

Referring now to the figures and the illustrated configurations depicted therein, a vehicle 100 is equipped with a traffic feature detection system 102 for identifying traffic features 12 within an environment 10 of the vehicle 100 (FIGS. 1 and 2). For example, the traffic feature detection system 102 is enabled by an electronic control unit (ECU) or control module 104 of the vehicle 100 having data processing hardware that executes instructions stored on memory hardware 106 of the vehicle 100. As the vehicle 100 travels along a road 14 of the environment 10, the traffic feature detection system 102 processes image data captured by a camera 108 of the vehicle 100 (e.g., a windshield mounted camera that views forward of the vehicle 100) to detect and identify the traffic features 12 within the environment 10, such as stop signs, speed limit signs, yield signs, traffic lights, pedestrian crossings, lane mergers and lane lines, crosswalks, railroad crossings, and the like. Based on identification of the traffic features 12, the traffic feature detection system 102 may transmit a notification 110 to a driver of the vehicle 100, such as a message generated at a display screen of the vehicle 100, and/or adjust operation of an advanced driving assist system (ADAS) 112 of the vehicle 100 as the ADAS at least partially controls operation of the vehicle 100 along the road 14.

As discussed below, image data captured by the camera 108 of the vehicle 100 and representative of traffic features 12 in the environment 10 may be processed for determining a health status or quality assessment 400 of the traffic feature 12. Although discussed as determining the health status 400 of the traffic feature 12 at a backend system 200 in communication with a telematics system 114 of the vehicle 100, it should be understood that at least portions of the methods and techniques described herein may be performed at the vehicle 100. Further, the health status 400 of the traffic feature 12 may be determined based on a single frame of image data, a series of frames of image data captured during a driving session of the vehicle 100 (e.g., video images captured by the camera 108), and/or an aggregation or set of image data collected by cameras at a plurality of vehicles (e.g., a fleet of vehicles).

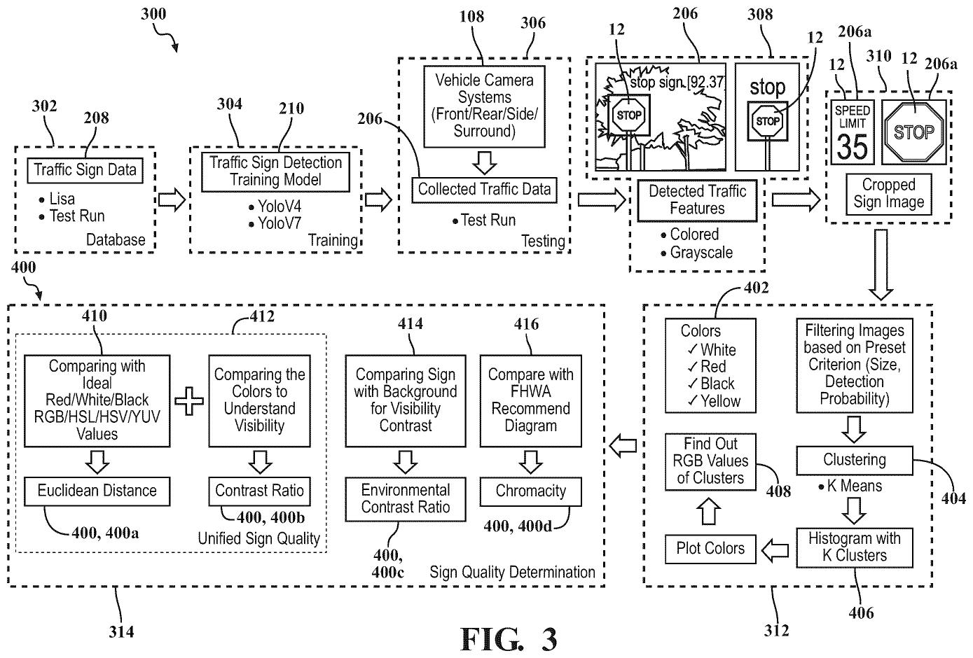

The illustrated configurations of FIGS. 1, 2, and 4 will be discussed in relation to the method 300 of FIG. 3. FIG. 3 provides a flowchart of an exemplary arrangement of operations for a method 300 of determining the health status 400 of the traffic feature 12 based on image data 206 received from the traffic feature detection system 102 of at least one vehicle 100 in communication with the backend system 200. For example, the backend system 200 may include a remote server or cloud computing system 202 executing instructions stored on memory storage 204.

At operation 302 of method 300, the backend system 200 receives training image data 208 representative of one or more traffic features 12 within the environment 10. For example, the training data 208 includes the LISA traffic sign dataset or other image data captured during testing procedures. The training data 208 may be stored in memory storage 204. At operation 304 of method 300, a training engine or a traffic sign detection training model 210 of the backend system, such as You Only Look Once version 4 (YOLOv4) or YOLOv7, is trained based on the training data 208. In some examples, the backend system 200 trains the traffic sign detection training model 210 based at least in part on the image data 206 captured by the vehicle 100 as it travels within the environment 10.

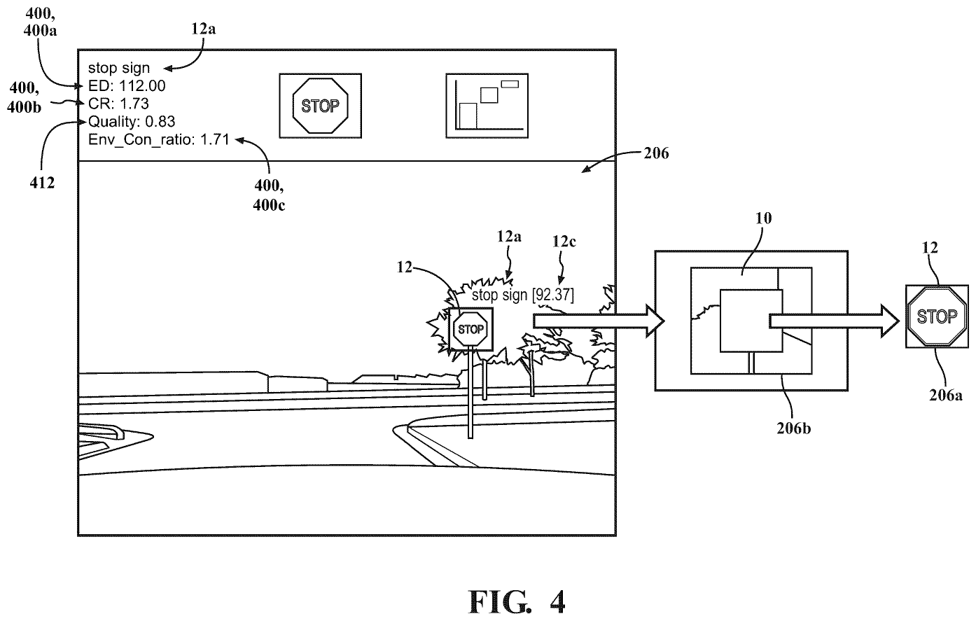

At operation 306 of method 300, the backend system 200 receives the captured image data 206 that is representative of a traffic feature 12 in the environment 10. As shown in FIG. 4, at operation 308 of method 300, the backend system 200 detects the traffic feature 12 in the image data 206 based on the trained traffic sign detection training model 210. For example, the traffic sign detection model 210 is configured to identify traffic features 12 that include stop signs, speed limit signs, yield signs, traffic lights, pedestrian crossings, lane mergers and lane lines, crosswalks, railroad crossings, and the like. The traffic sign detection model 210 is able to identify the traffic feature 12 in colored and grayscale image data 206.

Based on detecting the traffic feature 12 in the image data 206, the backend system 200 may crop or isolate a portion 206a of the image data 206, where the cropped portion 206a is representative of the traffic feature 12. In other words, at operation 310 of the method 300, the backend system 200 isolates the portion 206a of the image data 206 containing the traffic feature 12. As discussed further below, the backend system 200 may also isolate or crop a second portion 206b of the image data 206 representative of the environment 10 immediately surrounding or behind the traffic feature 12 in the image data 206.

As discussed further below, a quality determination module 212 of the backend system identifies a type or characterization 12a of the traffic feature 12 and, based on the type 12a, the quality determination module 212 determines one or more qualities 400a-d of the traffic feature 12 representative of the health status 400 of the traffic feature 12. The health status 400 may then be associated with the image data 206 and associated traffic feature 12 for further determinations. A data aggregation module 214 of the backend system 200 may receive the identified and/or cropped image data 206 for sorting the image data 206 based on the traffic feature 12 identified. For example, semantic data 216 associated with the image data 206, such as a physical distance 12b of the traffic feature 12 from the vehicle 100 in the image data 206, a unique identifier associated with the traffic feature 12, GPS coordinates of the vehicle 100 and a timestamp 12d of when the image data 206 was captured and the like, may be applied to a feature map 218 and associated with the image data 206 and identity of the traffic feature 12 by the aggregation module 214 for storage in a traffic feature database 220. Accordingly, image data 206 collected by cameras at a plurality of vehicles that is representative of the same traffic feature 12 at different instances may be aggregated or sorted together and stored in the traffic feature database 220 of memory storage 204. Put another way, image data 206 collected at different instances may be associated with the same traffic feature 12 so that the aggregation or collection of image data 206 may be used for determining the health status 400 for the traffic feature 12.

At operation 312 of the method 300, the quality determination module 212 determines a dominant color or pixel color value 402 in the image data 206 and associated with the traffic feature 12. For example, the quality determination module 212 may first filter the captured image data 206 based on criteria such as a maximum distance 12b of the traffic feature 12 from the vehicle 100 when the image data was captured, a minimum size of the traffic feature 12 in the image data 206, a confidence level 12c associated with identifying the traffic feature 12, and the like. The quality determination module 212 may only determine the health status 400 of the traffic feature 12 when the image data 206 satisfies the threshold criteria. Values or colors for each pixel or portion of the image data 206 may then be clustered, such as using K-means clustering, to generate a histogram 406 representative of the K-clusters 404, and the pixel color value 402 for the traffic feature 12 may be determined based on a most dominant K-cluster 404. That is, the pixel value or color or hue 402 is determined for the traffic feature 12 by determining, via K-means clustering, one or more K-clusters 404 of pixel values and determining the pixel color value 402 for the traffic feature 12 based on an average value or a median value of a primary or dominant K-cluster 404. The pixel color value 402 may be expressed as a red, green, and blue (RGB) coordinate value 408, as a grayscale pixel value, or using any suitable color coordinate system.

For example, when the traffic feature 12 is a stop sign, the pixel values for the image data 206 may be clustered generally into a red K-cluster 404 representative of the red portions of the traffic feature 12 in the image data 206 and a white K-cluster 404 representative of the white portions of the traffic feature 12 in the image data 206. Other K-clusters 404 may be representative of portions of the environment 10 within the cropped portion 206a of the image data 206, foreign objects or substances at the traffic feature 12 (e.g., a decal or paint), and the like. In the example of the stop sign, the pixel color value 402 for the traffic feature 12 may be determined as an average of the red K-cluster values 404.

At operation 314 of the method 300, the quality determination module 212 determines the health status 400 for the traffic feature 12 based on the determined pixel color value 402 for the traffic feature 12. For example, based on the type 12a of the traffic feature 12, the quality determination module 212 determines an expected pixel color value 410 for the traffic feature 12. In the example of the stop sign, the expected pixel color value 410 may be a hue of red defined by the Federal Highway Administration (FHWA). For example, the expected pixel color value 410 is derived from ideal chromaticity values recommended by the FHWA based on the type 12a of the traffic feature 12.

Based on a comparison of the expected pixel color value 410 and the determined pixel color value 402 for the traffic feature 12, the quality determination module 212 determines the health status 400 for the traffic feature 12. Because the expected pixel color value 410 and the determined pixel color value 402 may be represented as RGB coordinates 408, the comparison of the expected pixel color value 410 and the determined pixel color value 402 may be based on Euclidean distance 400, 400a between RGB coordinates 408 of the expected pixel color value 410 and the determined pixel color value 402. That is, the health status 400 may be at least partially based on the Euclidean distance 400a between the determined pixel color value 402 and the expected pixel color value 410 for the traffic feature 12. The greater the Euclidean distance 400a, the more likely the traffic feature 12 has degraded from its original state.

In some examples, the Euclidean distance 400a may be based on the expected pixel color value 410 and the determined pixel color value 402 in any suitable coordinate system, such as hue, saturation, and value (HSV) coordinates, hue, saturation, and lightness (HSL) coordinates, and luma, blue projection, and red projection (YUV) coordinates. Thus, the Euclidean distance 400a (ED) may be represented in RGB coordinates by the following:

$${ED}_{RGB} = \sqrt{{( {LM}_{R} - {I}_{R} )}^{2} + {( {LM}_{G} - {I}_{G} )}^{2} + {( {LM}_{B} - {I}_{B} )}^{2}}$$

where LM is representative of the determined pixel value 402 of the traffic feature 12 and I is representative of the expected pixel color value 410 of the traffic feature 12.

Similarly, the Euclidean distance 400a may be represented in HSV/HSL coordinates by the following:

$${ED}_{HSV / HSL} = \sqrt{{( {LM}_{H} - {I}_{H} )}^{2} + {( {LM}_{S} - {I}_{S} )}^{2} + {( {LM}_{V / L} - {I}_{V / L} )}^{2}}$$

The Euclidean distance 400a may be represented in YUV coordinates by the following:

$${ED}_{YUV} = \sqrt{{( {LM}_{Y} - {I}_{Y} )}^{2} + {( {LM}_{U} - {I}_{U} )}^{2} + {( {LM}_{V} - {I}_{V} )}^{2}}$$

Thus, the Euclidean distance 400a may compare the current color scale 402 of the traffic feature 12 with the recommended or expected color scale 410 of the type 12a of traffic feature 12 to measure how the color 402 of the traffic feature 12a has deteriorated from its initial or ideal value 410.

Further, the health status 400 for the traffic feature 12 may be based on a determined contrast ratio 400, 400b of the traffic feature 12. The contrast ratio 400b is representative of the ratio of the difference between the intensity/luminance between two or more target areas of the traffic feature 12. In the example of the stop sign, the contrast ratio 400b is representative of a difference between the red K-cluster 404 representative of the red portions of the traffic feature 12 in the image data 206 and the white K-cluster 404 representative of the white portions of the traffic feature 12 in the image data 206 and thus measures how visible one color is compared to the other. The contrast ratio 400b (u) may be represented by the following:

$$μ = \frac{{μ}_{l} - {μ}_{p}}{{μ}_{p}}$$

where μ₁ is representative of a first K-cluster 404 (e.g., white) and up is representative of a second K-cluster 404 (e.g., red). Thus, the health status 400 takes into account the contrast ratio 400b as representative of visibility of the traffic feature 12 for drivers. The higher the contrast ratio 400b, the more visible the traffic feature 12 may be to drivers.

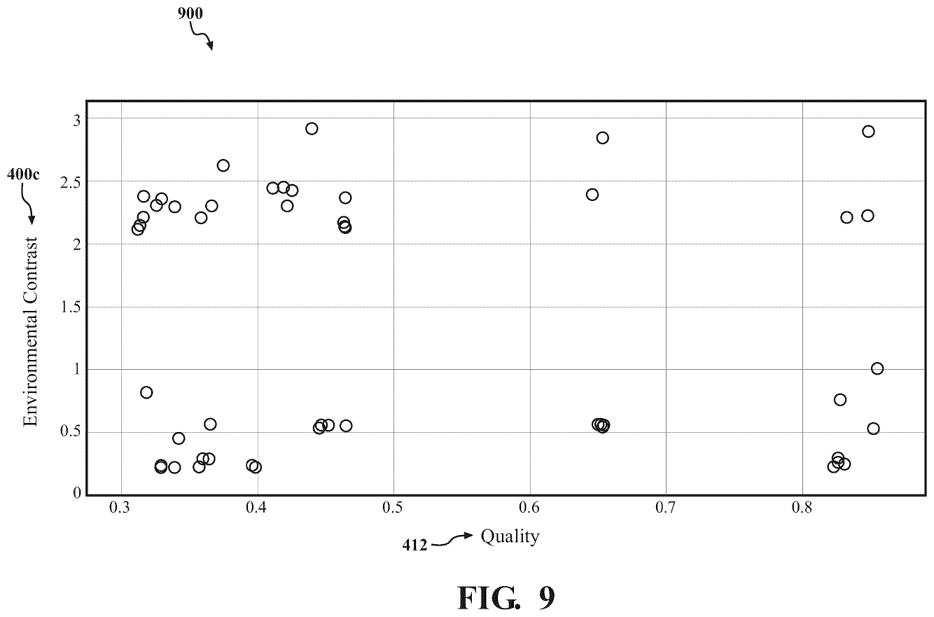

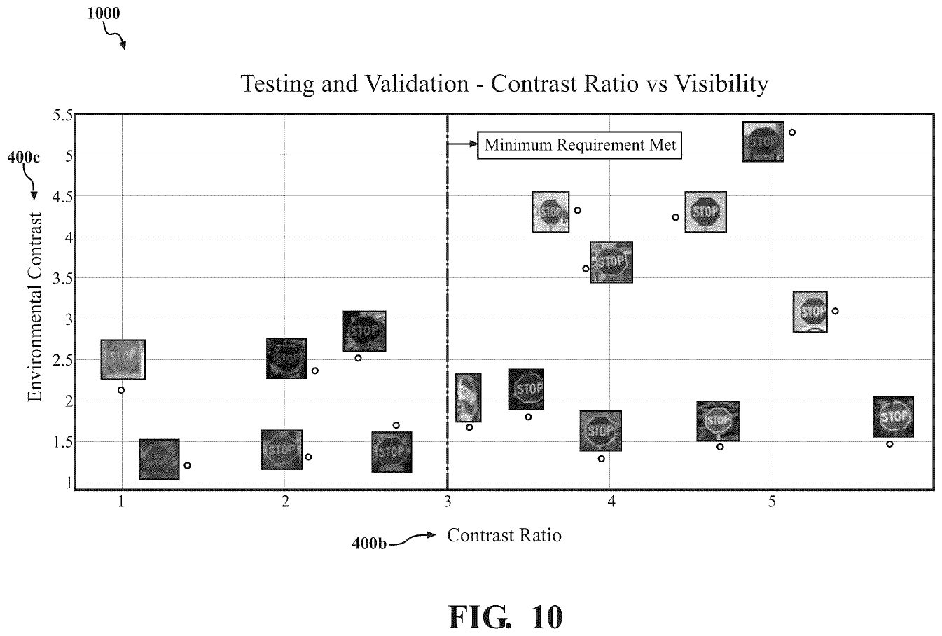

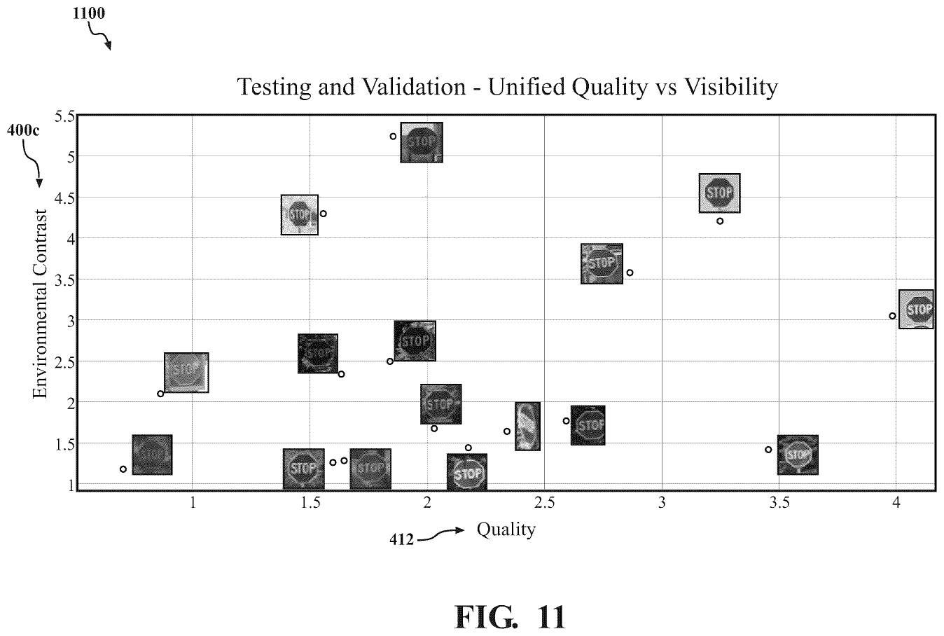

As shown in FIG. 3, the determined Euclidean distance 400a and the determined contrast ratio 400b for the traffic feature 12 may be combined to determine a unified health quality 412 for the traffic feature 12. In some examples, weights are assigned to the Euclidean distance 400a and the contrast ratio 400b to determine an average weighted score for the unified health quality 412. For example, both metrics may be normalized to a common range, such as [0, 1] or other suitable range. That is, the unified health quality 412 may be determined based on the Euclidean distance 400a and the contrast ratio 400b as a value between zero and one (e.g., FIG. 9) or along any suitable scale (e.g., FIGS. 10 and 11).

Further, a perceived brightness or level of ambient light present in the image data 206 may be considered when assigning weights to the Euclidean distance 400a and the contrast ratio 400b. That is, at least a portion of the image data 206 may be converted to L*a*b* color space, where L* represents the perceived brightness, a* represents green-red opponent colors, and b* represents blue-yellow opponent colors. L* may define black at 0.0 and may define white at 1.0. In some examples, the entire frame of image data 206 is converted to L*a*b* color space for determining the perceived brightness of the image data 206. Optionally, only a portion of the image data 206 (such as the determined pixel color value 402 for the traffic feature 12 or optionally respective pixel color values for any portion of the image data 206, such as portions of the image data 206 representative of the environment) is converted to L*a*b* color space for determining the perceived brightness. When the image data 206 is captured in a sunny environment, the perceived brightness of the image data 206 may be greater than 0.5, and the Euclidean distance 400a may be granted more weight as the more significant factor in determining the unified health quality 412 as image capture is considered to occur in more ideal conditions and less likely to be affected by weather conditions. When the image data 206 is captured in a dark or cloudy environment, the perceived brightness of the image data 206 may be less than 0.5, and the contrast ratio 400b may be granted more weight as the more significant factor as the colors of the traffic feature 12 may appear darker and contrast ratio 400b is less susceptible to dark conditions. Thus, the unified health status 412 (H) may be represented as:

$$H = α ( CR ) + β ( ED )$$

where α is representative of the weight applied to the contrast ratio 400b, CR is representative of the contrast ratio 400b, and β is representative of the weight applied to the Euclidean distance 400a. When perceived brightness is less than or equal to 0.5, then α is greater than β. When perceived brightness is greater than 0.5, then α is less than β. The sum of α and β is equal to one.

In some examples, the health status 400 of the traffic feature 12 may be further based on an environmental contrast ratio 400, 400c that is representative of the visibility of the traffic feature 12 compared to the background or environment surrounding the traffic feature 12. Thus, the quality determination module 212 may isolate the second portion 206b of the image data 206 that surrounds the first portion 206a, where the second portion 206b is representative of the environment 10 at or near the traffic feature 12. The quality determination module 212 determines a pixel color value 414 representative of the environment 10 in the second portion 206b, such as via K-means clustering, and determines the environmental contrast ratio 400c based on the determined pixel color value 402 of the traffic feature 12 and the determined pixel color value 414 for the environment 10. As shown in FIG. 4, the second portion 206b may be representative of only the environment 10 immediately surrounding the traffic feature 12 to provide a more accurate representation of visibility to drivers viewing the traffic feature 12.

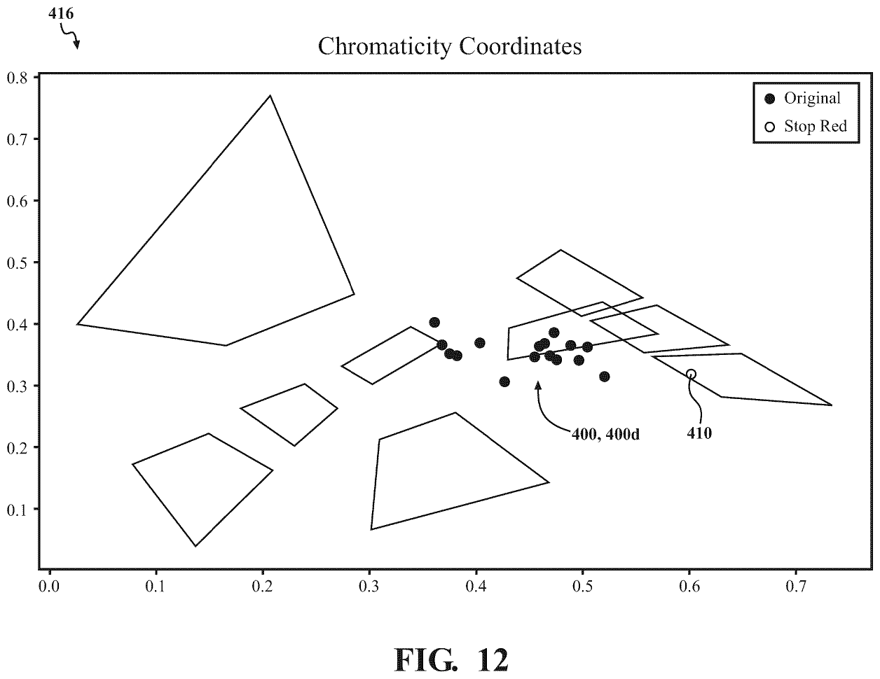

Moreover, the quality determination module 212 may determine a chromaticity 400, 400d associated with the traffic feature 12, such as to verify or validate the health status 400 determined for the traffic feature 12. For example, the quality determination module 212 may translate the determined pixel color value 402 for the traffic feature 12 to a corresponding chromaticity value 400d and plot the chromaticity along a chromaticity diagram 416 to compare the chromaticity value 400d for the traffic feature 12 to the expected value 410 in chromaticity for the type 12a of traffic feature 12 (FIG. 12). The expected value 410 for the traffic feature 12 may be based on guidance from the FHWA.

Referring to FIG. 2, the determined health status 400 and/or unified health quality 412 for the traffic feature 12 may be stored in the traffic feature database 220. Each unique traffic feature 12 may have one or more determined health status values 400 assigned to it. The vehicle 100 may be in communication with the traffic feature database 220, such as via the telematics system 114 of the vehicle 100, for adjusting operation of the traffic feature detection system 102 based on the determined health status 400 for the traffic feature 12.

For example, based on a position of the vehicle 100 determined by a navigation or GPS module 116 of the vehicle 100, the traffic feature detection system 102 may anticipate one or more traffic features 12 along a route of the vehicle 100. The navigation module 116 may adjust the route of the vehicle 100, such as to avoid traffic features 12 having determined health status 400 below a threshold level. Based on the health status 400 of the traffic feature 12, the system 102 may generate the notification 110 to the driver, such as to alert the driver that the health status 400 is indicative of a degraded traffic feature and thus the traffic feature 12 may not be visible to the driver. For example, based on the determined health status 400 for the traffic feature 12, the traffic feature detection system 102 may adjust operation, such as to highlight traffic features 12 having poor health status 400 in a heads-up display or full-windshield display. Further, the ADAS 112 may adjust operation, such as using the health status 400 as a weighting factor in using image data captured by the camera 108 or the map from the navigation module 116 in controlling the vehicle 100.

Moreover, the traffic feature database 220 may be in communication with an event processing module 222 of the backend system 200 that may identify and cluster traffic features 12 having health status 400 indicative of degradation. That is, the event processing module 222 may determine traffic features 12 having poor health status 400 and sort or group the traffic features 12, such as based on location of the traffic feature 12, type 12a of the traffic feature 12, and/or the municipality responsible for the traffic feature 12. Based on the determined health status 400 for the one or more traffic features 12 being indicative of degradation, a publisher module 224 of the backend system 200 may generate or publish an alert or report to repair the traffic feature 12. For example, the publisher module 224 may populate a publicly available database so that a municipality 20 with responsibility for the traffic feature 12 may be made aware of the health status 400.

For example, based on the unified health status 412 (i.e., the Euclidean distance 400a and the contrast ratio 400b) being indicative of poor quality of the traffic feature 12, the system 200 may recommend repair or replacement of the traffic feature 12. Based on the environmental contrast ratio 400c of the traffic feature 12 being indicative of the traffic feature 12 blending in or not being visible compared to its surrounding environment 10, the system 200 may recommend an adjustment to the traffic feature 12 or environment 10, such as a recommendation that trees behind the traffic feature 12 should be pruned, or a recommendation that the height of the traffic feature 12 should be adjusted to make the traffic feature 12 more visible. The chromaticity 400d of the traffic feature 12 may be analyzed for determining adherence of the traffic feature 12 to the FHWA guidelines for the type 12a of traffic feature 12.

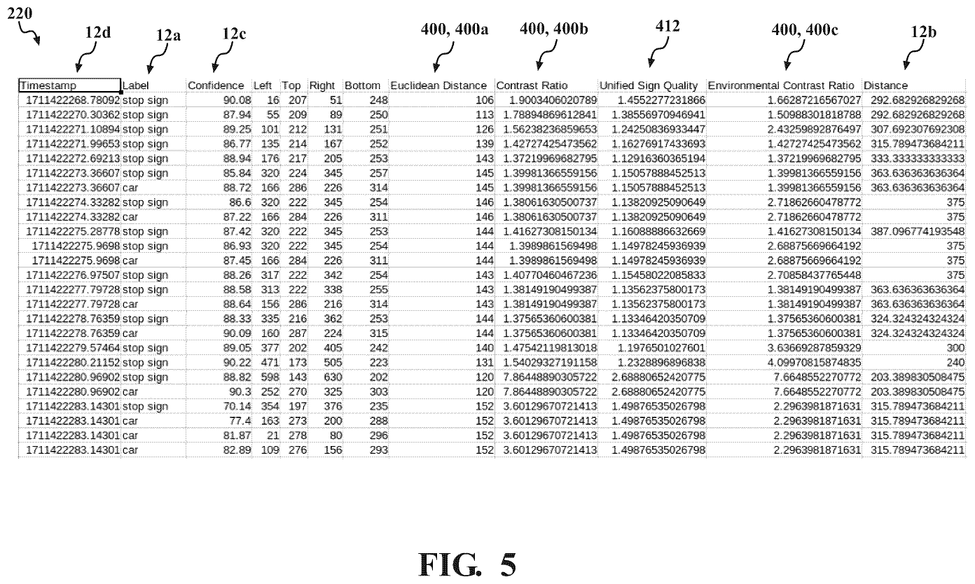

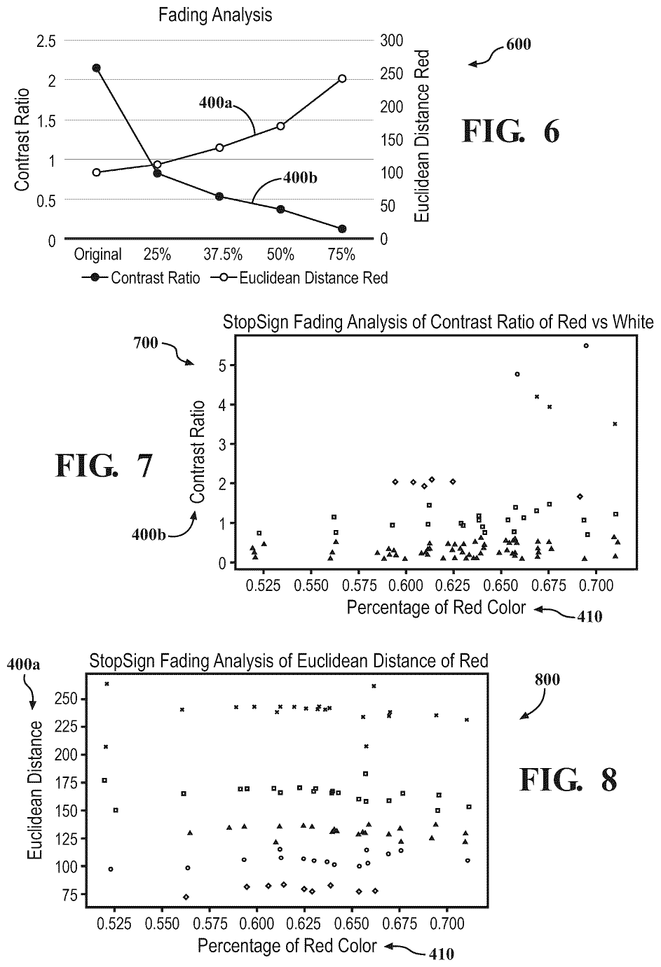

Referring to FIGS. 5-8, the determined health status values 400 associated with the traffic feature 12 and stored in the traffic feature database 220 are plotted to illustrate the effects of change in color and contrast ratio on the visibility of the traffic feature 12 for drivers and the traffic feature detection system 102. As shown in the diagram 600 of FIG. 6, as the determined Euclidean distance 400a of the traffic feature 12 increases over time (i.e., as the color of the traffic feature travels further from its original color), the contrast ratio 400b of the traffic feature 12 decreases. Put another way, as the fading of the traffic feature 12 increases, the Euclidean distance 400a increases and the contrast ratio 400b decreases, indicating a worsening in health status 400 of the traffic feature 12. That is, as the traffic feature 12 fades or discolors, the traffic feature 12 becomes more difficult to notice and more difficult to identify. In the example of the stop sign, and as shown in the diagram 700 of FIG. 7, the determined contrast ratio 400b between the red and white portions of the traffic feature 12 is highest when the traffic feature 12 has not substantially faded and thus the stop sign has retained a higher percentage of its original red color 410. Similarly, and as shown in the diagram 800 of FIG. 8, the Euclidean distance 400a between the determined pixel color value 402 and the expected pixel color value 410 of the traffic feature 12 may be lowest when the traffic feature 12 has not substantially faded and thus the stop sign has retained a higher percentage of its original red color 410. Thus, the Euclidean distance 400a and contrast ratio 400b are strongly correlated to good or poor health status 400 for the traffic feature 12.

FIG. 9 shows a diagram 900 charting experimental data that compares the determined environmental contrast ratio 400c of the traffic feature 12 to the unified health quality 412 of the traffic feature 12. As shown, the traffic sign detection system 102 may be capable of detecting traffic features 12 having low scores for unified health quality 412 (i.e., the traffic feature 12 may be damaged or deteriorated and thus difficult to identify) and/or low scores for environmental contrast ratio 400c (i.e., the traffic feature 12 may appear to blend in or not stand out compared to the surrounding environment 10). Moreover, FIG. 10 shows a diagram 1000 charting experimental data that compares the determined environmental contrast ratio 400c to the determined contrast ratio 400b for the traffic features 12, where the data may be validated with human perception values representative of the visibility of the traffic feature 12 to human drivers. As shown, traffic features 12 satisfying the minimum contrast ratio 400b and having higher environmental contrast ratio values 400c appear most visible. These were rated highest by the human perception values, thus validating the determined contrast ratio 400b as an efficient method for determining the health status 400 of the traffic feature 12. Similarly, FIG. 11 shows a diagram 1100 comparing the environmental contrast ratio 400c to the unified health quality 412.

Thus, the traffic feature detection system 102 in collaboration with the backend system 200 is configured to use deep learning models 210 to detect traffic features 12 (such as stop signs, speed limit signs, yield signs, and the like) and measure one or more health status values 400 associated with the traffic feature 12 (such as Euclidean distance 400a, contrast ratio 400b, environmental contrast ratio 400c, and/or chromaticity 400d). This provides an automated, quantitative health quality assessment for traffic features 12 that is devoid of human perception. By tracking the health status 400 in the traffic sign database 220, the system 200 may track current health quality 400 as well as deterioration rates of traffic features 12. This may allow for prediction of when traffic features 12 will need replacement or provide a recommendation when the traffic feature 12 is ready to be replaced. Accordingly, the system 200 ensures timely replacement of the traffic features 12, reduces monitoring costs for municipalities responsible for the traffic features 12, and improves road safety.

In some examples, the traffic feature detection system 102 and the backend system 200 may be configured to identify other roadside features, such as commercial signs on storefronts and billboard advertisements. Accordingly, the backend system 200 determines health status values 400 for the other roadside features, which may assist commercial entities in determining whether to repair or replace their storefront sign or develop different, more prominent billboard advertisements.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed on data processing hardware causes the data processing hardware to perform operations comprising:
receiving image data captured by a traffic feature detection system, the image data representative of a traffic feature within an environment;
identifying a type of the traffic feature;
isolating a portion of the image data containing the traffic feature;
based on the portion of the image data containing the traffic feature, determining a pixel color value for the traffic feature;
based on the type of the traffic feature, determining an expected pixel color value for the traffic feature; and
based on a comparison of the expected pixel color value and the determined pixel color value for the traffic feature, determining a health status for the traffic feature.

2. The method of claim 1, wherein determining the pixel color value for the traffic feature comprises:
determining, via k-means clustering, one or more clusters of pixel color values; and
determining the pixel color value for the traffic feature based on an average value of a primary cluster of the one or more clusters of pixel color values.

3. The method of claim 1, wherein the comparison of the expected pixel color value and the determined pixel color value is based on Euclidean distance between the expected pixel color value and the determined pixel color value, the expected pixel color value and the determined pixel color value represented by one selected from the group consisting of (i) RGB coordinate values, (ii) HSV coordinate values, (iii) HSL coordinate values, and (iv) YUV coordinate values.

4. The method of claim 1, wherein the health status for the traffic feature is further based on a determined contrast ratio of the traffic feature.

5. The method of claim 1, wherein the operations further comprise:
isolating a second portion of the image data that surrounds the portion of the image data containing the traffic feature; and
determining a pixel color value for the environment based on the second portion of the image data.

6. The method of claim 5, wherein the health status for the traffic feature is further based on a comparison of the determined pixel color value for the traffic feature and the determined pixel color value for the environment.

7. The method of claim 1, wherein the image data is aggregated from traffic feature detection systems equipped at a plurality of vehicles.

8. The method of claim 1, wherein the comparison of the expected pixel color value and the determined pixel color value is based on a level of ambient light present in the image data.

9. The method of claim 1, wherein the operations further comprise, based on the determined health status for the traffic feature, adjusting operation of the traffic feature detection system.

10. The method of claim 1, wherein the operations further comprise, based on the determined health status for the traffic feature being indicative of degradation, generating an alert to repair the traffic feature.

11. A system comprising:
memory hardware storing instructions that, when executed on data processing hardware in communication with the memory hardware, cause the data processing hardware to perform operations comprising:
receiving image data captured by a traffic feature detection system, the image data representative of a traffic feature within an environment;
identifying a type of the traffic feature;
isolating a portion of the image data containing the traffic feature;
based on the portion of the image data containing the traffic feature, determining a pixel color value for the traffic feature;
based on the type of the traffic feature, determining an expected pixel color value for the traffic feature; and
based on a comparison of the expected pixel color value and the determined pixel color value for the traffic feature, determining a health status for the traffic feature.

12. The system of claim 11, wherein determining the pixel color value for the traffic feature comprises:
determining, via k-means clustering, one or more clusters of pixel color values; and
determining the pixel color value for the traffic feature based on an average value of a primary cluster of the one or more clusters of pixel color values.

13. The system of claim 11, wherein the comparison of the expected pixel color value and the determined pixel color value is based on Euclidean distance between the expected pixel color value and the determined pixel color value, the expected pixel color value and the determined pixel color value represented by one selected from the group consisting of (i) RGB coordinate values, (ii) HSV coordinate values, (iii) HSL coordinate values, and (iv) YUV coordinate values.

14. The system of claim 11, wherein:
the operations further comprise:
isolating a second portion of the image data that surrounds the portion of the image data containing the traffic feature; and
determining a pixel color value for the environment based on the second portion of the image data; and
determining the health status for the traffic feature is further based on a comparison of the determined pixel color value for the traffic feature and the determined pixel color value for the environment.

15. The system of claim 11, wherein the image data is aggregated from traffic feature detection systems equipped at a plurality of vehicles.

16. A vehicle comprising:
memory hardware storing instructions that, when executed on data processing hardware in communication with the memory hardware, cause the data processing hardware to perform operations comprising:
receiving image data captured by a traffic feature detection system of the vehicle, the image data representative of a traffic feature within an environment;
identifying a type of the traffic feature;
isolating a portion of the image data containing the traffic feature;
based on the portion of the image data containing the traffic feature, determining a pixel color value for the traffic feature;
based on the type of the traffic feature, determining an expected pixel color value for the traffic feature;
based on a comparison of the expected pixel color value and the determined pixel color value for the traffic feature, determining a health status for the traffic feature; and
based on the determined health status for the traffic feature, adjusting operation of the traffic feature detection system.

17. The vehicle of claim 16, wherein determining the pixel color value for the traffic feature comprises:
determining, via k-means clustering, one or more clusters of pixel color values; and
determining the pixel color value for the traffic feature based on an average value of a primary cluster of the one or more clusters of pixel color values.

18. The vehicle of claim 16, wherein the comparison of the expected pixel color value and the determined pixel color value is based on Euclidean distance between the expected pixel color value and the determined pixel color value, the expected pixel color value and the determined pixel color value represented by one selected from the group consisting of (i) RGB coordinate values, (ii) HSV coordinate values, (iii) HSL coordinate values, and (iv) YUV coordinate values.

19. The vehicle of claim 16, wherein:
the operations further comprise:
isolating a second portion of the image data that surrounds the portion of the image data containing the traffic feature; and
determining a pixel color value for the environment based on the second portion of the image data; and
determining the health status for the traffic feature is further based on a comparison of the determined pixel color value for the traffic feature and the determined pixel color value for the environment.

20. The vehicle of claim 16, wherein the image data is aggregated from traffic feature detection systems equipped at a plurality of vehicles.
